(19) United States
(12) Patent Application Publication
(10) Pub. No.: US 2014/0004488 A1
(43) Pub. Date: Jan. 2, 2014

(54) TRAINING, SKILL ASSESSMENT AND MONITORING USERS OF AN ULTRASOUND SYSTEM

(71) Applicants: Ron Tepper, Herzlia (IL); Roman Shklyar, Holon (IL)

(72) Inventors: Ron Tepper, Herzlia (IL); Roman Shklyar, Holon (IL)

(73) Assignee: Mor Research Applications Ltd., Tel-Aviv (IL)

(21) Appl. No.: 14/005,289

(22) PCT Filed: Mar. 13, 2012
(86) PCT No.: PCT/IL2012/050086

§ 371 Date: Sep. 16, 2013

Related U.S. Application Data
(60) Provisional application No. 61/453,593, filed on Mar. 17, 2011.
(60) Provisional application No. 61/453,594, filed on Mar. 17, 2011.

(51) Int. Cl. G09B 23/28

(52) U.S. Cl. CPC G09B 23/286
USPC 434/219

(57) ABSTRACT

A system for training practitioners in use of an ultrasound system including a unit for managing workflow of an ultrasound training session, a user interface for providing ultrasound training session instructions to a practitioner operating an ultrasound machine and for receiving input from a trainee, a unit for communication with the ultrasound machine, for collecting one or more ultrasound images produced during the training session from the ultrasound machine, a unit for image processing the ultrasound images, and a unit for assessing quality of the ultrasound images. A method for monitoring practitioner proficiency in use of an ultrasound system including providing the practitioner with an ultrasound task definition, collecting one or more ultrasound images produced by the practitioner during performance of the ultrasound task from an ultrasound machine, image processing the ultrasound images, and assessing quality of the ultrasound images. Related apparatus and methods are also described.

### RELATED APPLICATIONS

The present application claims the benefit of priority of U.S. Provisional Patent Applications No. 61/453,594 filed Mar. 17, 2011, and No. 61/453,593 filed Mar. 17, 2011 the contents of which are incorporated herein by reference in their entirety. The present application is related to co-filed, co-pending and co-assigned PCT patent application (attorney docket 53446), also entitled “TRAINING, SKILL ASSESSMENT AND MONITORING USERS IN ULTRASOUND GUIDED PROCEDURES” the disclosure of which is incorporated herein by reference.

### FIELD AND BACKGROUND OF THE INVENTION

The present invention, in some embodiments thereof, relates to a system for training users of ultrasound systems such as medical staff (physicians, sonographers, students nurses) and, in some embodiments thereof, to a system for monitoring users of an ultrasound system.

U.S. Pat. No. 5,609,485 to Bergman et al. describes a medical reproduction system. The medical reproduction system is a computer-based interactive reproduction system device designed to be used by physicians and technicians in medical training and diagnosis using medical systems such as ultrasound machines. Biological data is collected from a living body and stored in memory. An operator manipulates a simulated sensor over a transmitter which may be attached to a simulated body. The transmitter transmits position data to a receiver in the sensor. The reproduction unit processes the preset biological data and displays data corresponding to the position of the sensor with respect to the transmitter.

U.S. Pat. No. 6,210,168 to Aiger et al. describes a Doppler ultrasound simulator—a method and system for simulating, on a B-mode ultrasound simulator, a D-mode and C-mode Doppler ultrasound examination. Velocity and sound data describing blood flow at selected locations within blood vessels of a patient are gathered during an actual Doppler ultrasound examination. The gathered data are processed off-line to generate sets of flow velocity and sound values which describe blood flow at selected locations in a virtual B-mode frame buffer, and are stored in memory. Doppler simulation at a designated location on a the B-mode image generated from the virtual frame buffer is achieved by performing bilinear interpolation, at the time of simulation, from the data stored in memory, so as to determine flow velocity and sound values for all designated virtual frame buffer voxels. The interpolated flow velocity values are depicted as either a gray scale Doppler spectral waveform or a color scale flow map on the screen of the B-mode ultrasound simulator, and the sound values are depicted as an audible signal simulating a Doppler sound waveform.

U.S. Pat. No. 7,545,985 to Zhang et al. describes a method and system for learning-based quality assessment of images. An image quality assessment system trains an image classifier based on a training set of sample images that have quality ratings. To train the classifier, the assessment system generates a feature vector for each sample image representing various attributes of the image. The assessment system may train the classifier using an adaptive boosting technique to calculate a quality score for an image. Once the classifier is trained, the assessment system may calculate the quality of an image by generating a feature vector for that image and applying the trained classifier to the feature vector to calculate the quality score for the image.

US Published Patent Application number 2003/0198936 of Wen et al. describes a real-time learning assessment method for interactive teaching conducted by means of portable electronic devices. The real-time learning assessment method for interactive teaching conducted by means of portable electronic devices. The invention involves using an assessment system to carry out real-time assessment of the result of learning conducted by means of portable electronic devices. The assessment system compiles the statistics for the number of times students raise questions with portable electronic devices during a semester and their scores on tests taken with portable electronic devices, for creating records of routine assessment conducted by means of portable electronic devices, with a view to improving the existing teaching methods and the routine academic performance assessment methods.

US Published Patent Application number 2005/0277096 of Hendrickson et al. describes a medical simulation system and method. A portable medical simulation system and method employs an artificial patient with a built-in haptic interface device, with up to four carriages for engaging different diameter catheters. A catheter stabilizer between each carriage expands and contracts in an accordion fashion as the carriages move in relation to each other, preventing the catheter from bending and bowing. A contrast display visual effect derived from a particle emitter software tool simulates the release of radiopaque dye within a simulated vasculature system for display on a monitor. A computer software based system is used for generating haptic effects on the catheter through control signals passed to each of the carriage motors controlling translation movement of the catheter and magnetic particle brakes controlling rotational movement of the catheter.

US Published Patent Application number 2007/0207448 of Glaser et al. describes a method and system for using simulation techniques in ophthalmic surgery training. Each type of ophthalmic surgery, such as retinal or cataract surgery, is broken down into a sequence of surgical tasks, and each task is programmed into the system. A user practices each task via a simulator on a virtual human subject until a pre-determined level of skill is acquired for the task. The present invention objectively and effectively assesses a user's skill and expertise level in performing ophthalmic surgery via gated performance testing, thereby ensuring that the user has a pre-determined skill and expertise level, and eliminating undue risk to patients.

US Published Patent Application number 2008/0085501 of Novack et al. describes a system and methods for interactive assessment of performance and learning. Systems and methods provide a computer-implemented interactive system and methods allowing the interactive assessment of performance and learning. In an illustrative implementation, a computing environment comprises a data store having content for dissemination to participating users as part of an education/training program, and an assessment engine having facilities to allow the real-time storage and monitoring of a test session engaged in by a participating user in which the participating user can demonstrate knowledge of selected subject matter through the interaction, in real time, using video/audio teleconferencing, with one or more cooperating parties. In an illustrative operation, participating users are provided access to the exemplary computing environment as part of an e-learning application providing learning content to the user. Participating users can interact in real time with cooperating parties as part of an assessment process of the user. Such interaction can be realized through computer enabled video/audio teleconferencing.

Published US Patent Application number 2008/0293029 of Jason Wilkins et al describes an Ultrasound Training Mannequin. The ultrasound training mannequin is a device that provides a realistic medical training device for use by medical personnel, especially those in the field of emergency medicine, to gain experience in applying and analyzing the results of common ultrasound examinations. The mannequin comprises a life-size model of the male torso. The mannequin has a simulated human skin and tissue structure made of a silicone. Internal organs, such as the lungs, heart, liver, kidneys, gall bladder, urinary bladder, and spleen are placed inside the model in their normal occurring relative positions. Heavier organs are modeled with a variable density silicone material to simulate the actual sonic density of these organs. The lungs are modeled with a variable density foam material to simulate the sonic density of actual lungs. The mannequin also includes artificial venous and arterial channels emanating from and terminating at the heart.

### SUMMARY OF THE INVENTION

The present invention, in some embodiments thereof, relates to methods and systems for training practitioners such as medical staff (physicians, sonographers, students nurses) in use of an ultrasound system and, in some embodiments thereof, to a system for monitoring and skill assessment of practitioners using an ultrasound system.

Typically, a practitioner is given or selects an ultrasound task to perform. The practitioner performs the task, and the system collects data about the performance. The system automatically evaluates the quality of performance. A result of the quality evaluation is used to provide feedback to the practitioner, and/or feedback to a trainer, and/or to otherwise monitor knowledge and quality of ultrasound use by ultrasound practitioners.

When an embodiment of the invention is used as a system for monitoring users of an ultrasound system, the users may perform their usual ultrasound tasks, and be monitored by the system while performing the tasks. The monitoring optionally provides feedback to the users and optionally to management, of quality of performance of the tasks. The monitoring system may pick out tasks which were performed by users in order to monitor the tasks, for example, tasks in which the users were deficient during prior monitoring, and grade those tasks; and/or the monitoring system may suggest which tasks the monitored users need to perform in order to produce monitoring results according to a monitoring schedule.

The ultrasound task may be, by way of a non-limiting example, producing a specific ultrasound image.

The ultrasound task may be, by way of a non-limiting example, producing a specific ultrasound image at a specific body location and a specific ultrasound probe direction.

The term “task” in all its grammatical forms is used throughout the present specification and claims interchangeably with the term “training session” and its corresponding grammatical forms.

The ultrasound task optionally tests technical ability and optionally an ability to choose correct ultrasound machine settings, often both abilities simultaneously, to generate a good image according to the task at hand.

Scenarios in which some embodiments of the invention may be used include: an ultrasound training center; a training department of a medical center; wards within a medical center; and similar veterinary medical scenarios

Some example applications in which embodiments of the invention may be used include: training, testing, provide real-time feedback during use of an ultrasound system; monitoring, evaluation and grading of ultrasound practitioners.

The term “practitioner” in all its grammatical forms, and the term “user” in all its grammatical forms, are used throughout the present specification and claims to mean persons being trained by and/or monitored by and/or using an embodiment of the present invention.

Some example embodiments of the invention are as an add-on box to an ultrasound system; an add-on box packaged within an ultrasound machine enclosure; a computer running software and connected to an ultrasound machine (which itself often contains a computer); and software added to a computer managing an ultrasound system.

Ultrasound Subjects

An ultrasound session managed using an example embodiment of the invention may be performed on ultrasound subjects such as: an Ultrasound Training Mannequin such as described in above-mentioned Published US Patent Application number 2008/0293029 of Jason Wilkins et al or an improvement thereon; an actual patient; a practice cadaver; and animals, optionally animals for which an ultrasound image bank exists such as described in above-mentioned U.S. Pat. No. 5,609,485 to Bergman et al.

In some example embodiments of the invention the Ultrasound Training Mannequin contains anatomically correct vascular anatomy of the right upper thorax and neck, including the internal jugular vein, subclavian vein, brachiocephalic vein, axillary vein, carotid artery, axillary artery, and subclavian artery.

In some example embodiments of the invention the Ultrasound Training Mannequin contains an anatomically correct fetus inside a fluid filled cylinder.

In some example embodiments of the invention the Ultrasound Training Mannequin contains an anatomically normal female pelvic model including a uterus, fallopian tubes, ovaries and iliac vessels.

In some example embodiments of the invention the Ultrasound Training Mannequin includes both abdominal and vaginal scanning access, allowing a variety of transducer orientations.

Some example embodiments of the invention perform their task when connected to standard ultrasound imaging systems, configured with an appropriate transducer, such as an abdominal transducer, a vaginal transducer, and so on.

In some example embodiments of the invention the Ultrasound Training Mannequin contains a Doppler String Phantom. A Phantom is a device containing one or more substances which produce a response similar to patient anatomy, providing an opportunity to explore the phantom with Doppler ultrasound as if it were actual anatomy. By way of a non-limiting example, the Doppler String Phantom CIRS 043 by SuperTech® of Elkhart, Ind., USA, has a crystal controlled motor which accurately generates sixteen pre-programmed waveforms using string target technology, and enables custom programming of waveforms.

According to an aspect of some embodiments of the present invention there is provided a system for training practitioners in use of an ultrasound system including a unit for managing workflow of an ultrasound training session, a user interface for providing ultrasound training session instructions to a practitioner operating an ultrasound machine and for receiving input from a trainee, a unit for communication with the ultrasound machine, for collecting one or more ultrasound images produced during the training session from the ultrasound machine, a unit for image processing the ultrasound images, and a unit for assessing quality of the ultrasound images.

According to some embodiments of the invention, further including a unit for measuring ultrasound probe orientation.

According to some embodiments of the invention, further including a unit for measuring mannequin orientation.

According to some embodiments of the invention, the unit for image processing the ultrasound images is configured to perform automatic feature extraction on the ultrasound images.

According to some embodiments of the invention, further including a database of ultrasound training sessions.

According to some embodiments of the invention, the database includes target ultrasound images associated with the training sessions.

According to some embodiments of the invention, the database includes metadata associated with the training sessions.

According to some embodiments of the invention, the database includes metadata associated with the target ultrasound images.

According to some embodiments of the invention, the unit for communication with the ultrasound machine is also configured to collect ultrasound machine settings.

According to some embodiments of the invention, further including a unit for measuring ultrasound probe position and ultrasound probe orientation.

According to some embodiments of the invention, further adapted to record a series of positions and orientations used while performing an ultrasound task.

According to an aspect of some embodiments of the present invention there is provided a method for training practitioners in use of an ultrasound system including providing ultrasound training session instructions to a practitioner operating an ultrasound machine, collecting one or more ultrasound images produced during the training session from the ultrasound machine, image processing the ultrasound images, and assessing quality of the training session based, at least in part, on assessing quality of the ultrasound images.

According to some embodiments of the invention, the assessing quality of the ultrasound images includes measuring contrast of the ultrasound images.

According to some embodiments of the invention, the image processing includes feature extraction.

According to some embodiments of the invention, the providing ultrasound training session instructions includes providing instructions from a database of ultrasound training sessions, and the image processing the ultrasound images includes comparing the ultrasound images produced during the training session to ultrasound images stored in the database of ultrasound training sessions.

According to some embodiments of the invention, the assessing quality of the training session includes comparing metadata associated with the ultrasound images produced during the training session to metadata stored in the database of ultrasound training sessions.

According to some embodiments of the invention, further including collecting one or more ultrasound machine settings in use during the training session, and in which the assessing quality of the training session includes comparing the one or more ultrasound machine settings in use during the training session to ultrasound machine settings stored in the database of ultrasound training sessions.

According to some embodiments of the invention, the assessing quality of the training session includes comparing measurements made by the practitioners during the training session to metadata stored in the database of ultrasound training sessions.

According to some embodiments of the invention, the assessing quality of the training session includes comparing measurements made by the practitioners during the training session to measurements of features in the ultrasound images performed by automatic feature extraction on the ultrasound images.

According to some embodiments of the invention, further including collecting one or more ultrasound machine settings in use during the training session, and performing the assessing based, at least in part, on the ultrasound machine settings.

According to some embodiments of the invention, the assessing quality of the training session includes comparing ultrasound machine settings to ultrasound machine settings stored in the database of ultrasound training sessions.

According to some embodiments of the invention, further including collecting one or more ultrasound probe position and ultrasound probe orientation measurements, and performing the assessing based, at least in part, on the ultrasound probe position and ultrasound probe orientation measurements.

According to some embodiments of the invention, further including recording a series of positions and orientations used while performing an ultrasound task, and performing the assessing based, at least in part, on the series.

According to an aspect of some embodiments of the present invention there is provided software for training practitioners in use of an ultrasound system including a unit for managing workflow of an ultrasound training session, a user interface for providing ultrasound training session instructions to a practitioner operating an ultrasound machine and for receiving input from a trainee, a unit for communication with the ultrasound machine, for collecting one or more ultrasound images produced during the training session from the ultrasound machine, a unit for image processing the ultrasound images, and a unit for assessing quality of the ultrasound images.

According to an aspect of some embodiments of the present invention there is provided software for monitoring practitioner use of an ultrasound system including a unit for managing workflow of an ultrasound training session, a user interface for providing ultrasound training session instructions to a practitioner operating an ultrasound machine and for receiving input from a trainee, a unit for communication with the ultrasound machine, for collecting one or more ultrasound images produced during the training session from the ultrasound machine, a unit for image processing the ultrasound images, and a unit for assessing quality of the ultrasound images.

According to an aspect of some embodiments of the present invention there is provided a method for monitoring practitioner proficiency in use of an ultrasound system including providing the practitioner with an ultrasound task definition, collecting one or more ultrasound images produced by the practitioner during performance of the ultrasound task from an ultrasound machine, image processing the ultrasound images, and assessing quality of the ultrasound images.

According to an aspect of some embodiments of the present invention there is provided a method for monitoring practitioner proficiency in use of an ultrasound system including having the practitioner perform an ultrasound task on a system of claim 1, and assessing quality of the ultrasound task.

According to some embodiments of the invention, further including comparing measurements of a fetus made by the practitioner based on the ultrasound task, to measurements made after birth.

According to some embodiments of the invention, further including comparing measurements made by the practitioner based on the ultrasound task, to measurements made post-mortem.

According to some embodiments of the invention, further including comparing measurements made by the practitioner based on the ultrasound task, to measurements made after surgery.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified illustration of an ultrasound Training, Assessment, and Monitoring (TAM) system constructed and operational according to an example embodiment of the invention;

FIG. 2A is a simplified block diagram illustration of an ultrasound TAM system constructed and operational according to an example embodiment of the invention;

FIG. 2B is a simplified block diagram illustration of an ultrasound TAM system constructed and operational according to another example embodiment of the invention;

FIG. 2C is a simplified block diagram illustration of an ultrasound TAM system constructed and operational according to yet another example embodiment of the invention;

FIG. 3A is a simplified flow chart illustration of an example embodiment of the invention, used for training ultrasound practitioners;

FIG. 3B is a simplified flow chart illustration of another example embodiment of the invention, used for training ultrasound practitioners;

FIG. 4 is a simplified flow chart illustration of an example embodiment of the invention, used for monitoring ultrasound practitioners; and

FIG. 5 is a simplified illustration of an ultrasound user monitoring system, constructed and operational according to an example embodiment of the invention.

### DESCRIPTION OF SPECIFIC EMBODIMENTS OF THE INVENTION

The present invention, in some embodiments thereof, relates to a system for training practitioners, such as medical staff (physicians, sonographers, students nurses) in use of an ultrasound system and, in some embodiments thereof, to a system for monitoring practitioners using an ultrasound system.

The system described in above-mentioned U.S. Pat. No. 5,609,485 can be used for training practitioners in using ultrasound machines. Biological data is collected from a living body and stored in memory. As the practitioner manipulates a simulated sensor over a simulated body, a mannequin, a transmitter transmits position data to a receiver in a sensor. The training system processes the biological data and displays data corresponding to the position of the sensor with respect to the transmitter. Such a training system displays to the trainee-practitioner ultrasound images taken by others corresponding to the position of the simulated sensor.

The above training system does not evaluate the trainee's actual results in using an ultrasound system.

In order to perform medical surveys with an ultrasound system, a practitioner should, based on the medical task at hand, choose correct ultrasound settings such as a suitable probe, suitable ultrasound frequency, and suitable amplitude; properly perform the mechanical manipulation leading to capturing an image of a desired ultrasound cross-section; sometimes properly adjust display settings such as magnification/contrast/brightness; and probe orientations sometimes perform measurements by placing a cursor at selected points in the image.

Having a trainee perform an actual ultrasound on an actual subject, and comparing the image with a good reference image, or target image, can improve training, taking results of the trainee's work, such as an ultrasound image and detailed measurements, rather than only a position and direction of a simulated sensor, as taught by the above-mentioned U.S. Pat. No. 5,609,485. In fact, in some embodiments of the invention, quality is evaluated without use of position measurements. For example, image comparison optionally provides the quality evaluation without need for position measurement. By the way, image comparison is often more sensitive to position than position measurement.

Relative to the system taught by the above-mentioned U.S. Pat. No. 5,609,485, embodiments of the invention enable a trainee/practitioner to use an actual ultrasound machine as in use in the practitioner's clinic, an actual probe, to obtain a real image. The real image will suffer from the mistakes which the practitioner makes, and will not be a simulated image which might, or might not, truly correspond to what the practitioner can achieve in a real situation.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

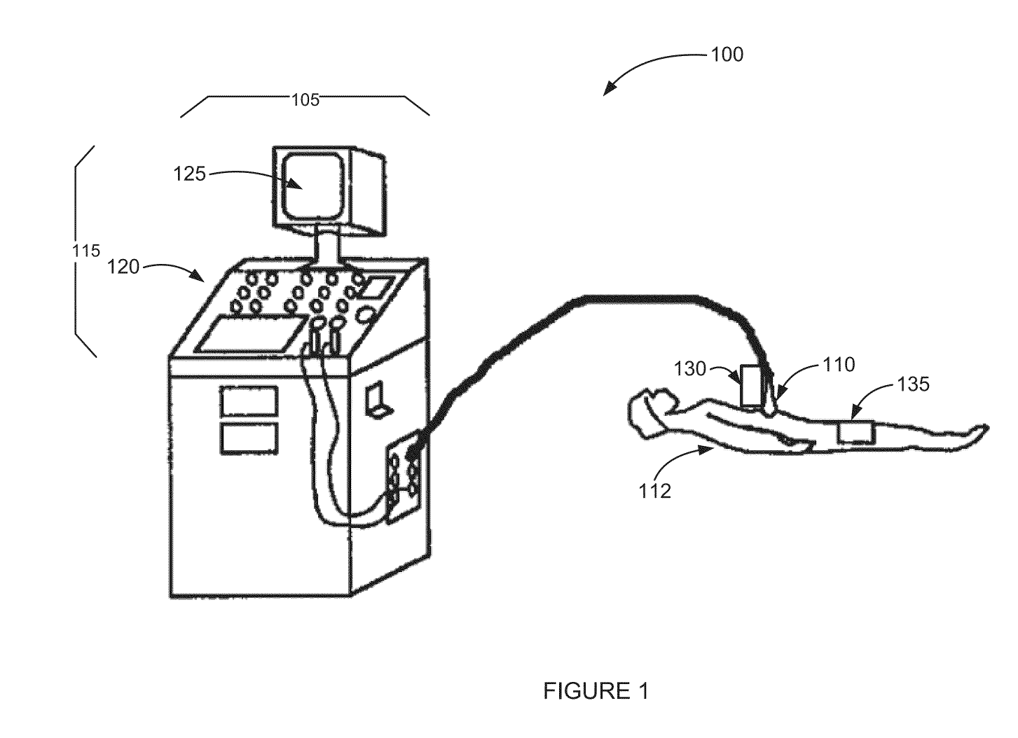

Reference is now made to FIG. 1 which is a simplified illustration of an ultrasound system 100 constructed and operational according to an example embodiment of the invention.

FIG. 1 illustrates the ultrasound system 100 in use. FIG. 1 is much simplified, to highlight similarities of using the ultrasound system 100 to using a standard ultrasound workstation.

FIG. 1 depicts an ultrasound workstation 105, connected to an ultrasound probe 110, placed on an ultrasound subject 112, such as a patient or a mannequin or such-like subjects. The ultrasound workstation 105 includes a user interface 115, for input 120 and for output (display) 125.

In some embodiments of the invention, a trainee-practitioner uses the ultrasound workstation 105 to capture an ultrasound image, and then provides an input indicating that the captured image is to be evaluated. The image is compared to a target image, and a quality assessment is made of the captured image by comparison to the target image.

In some embodiments of the invention, the trainee-practitioner is provided an ultrasound task as a written instruction. In some embodiments of the invention, the trainee-practitioner is provided the ultrasound task by being shown a target image, the likes of which the trainee-practitioner is to produce. In some embodiments of the invention, the trainee-practitioner is provided the ultrasound task as a combination of written instruction and by being shown the target image.

As described in above-mentioned U.S. Pat. No. 5,609,485 to Bergman et al., a 6 Degrees-of-Freedom (DOF) receiver 130 is optionally connected to the ultrasound probe 110, for detecting signals transmitted from a 6 DOF transmitter 135, in order to detect orientation and position of the ultrasound probe 110.

An Ultrasound Task Database

In some embodiments of the invention an ultrasound task database is kept. Some or all of the following metadata is optionally kept associated with an ultrasound task in the ultrasound task database: a task identification, and one or more task-steps included in the ultrasound task. Each of the task-steps in the database is optionally kept associated with:

instructions regarding the ultrasound task-step;

a possible clinical story associated with a rationale for performing the tasks, such as fetus scan, amniotic fluid check, and so on;

probe location coordinates;

probe orientation;

ultrasound machine settings;

an acceptable range for the location and direction coordinates and for the machine settings;

quality grades associated with the location and with the direction coordinates, and with the machine settings;

a target image;

a diagnosis optionally associated with the image; and

one or more measurements optionally associated with the image.

Additional data which may be kept in the database can include:

Spatial coordinates, such as angle and position, of a mannequin when used for an ultrasound task.

### Example Data which May be Associated Per Task and/or Sub-Task

Each ultrasound task and/or sub-task which is performed can optionally have one or more of the following data items associated with it:

a unique ID;

ultrasound settings for a beginning of the task or sub-task, to be set automatically and/or by an instructor;

one or more target result images;
for each target result image:
   an angle setting;
   a zoom setting;
   a depth setting;
   a focus location setting;
   an ultrasound program setting (for example—“first trimester pregnancy”, “second trimester pregnancy”, “fetal echo”, “gynecology”, “cardiac echo”, and so on);
   an OTI setting;
   a Harmonic Frequency setting;
   a power setting;
   an R setting;
   a gain setting;
   TGC (Time Gain Compensation) setting;

if the task includes a mannequin or artificial ultrasound subject:
a position of the mannequin;
an angle of rotation of the subject;

which ultrasound probe was used; and

which transducer was used.

An example form is brought below, displayed as Table 1, which, in some embodiments, may be a paper form, and in other embodiments may be implemented via computer, includes example data from the above list of data. Fields in the example form are optionally partially filled by a trainer and/or monitoring person prior to setting an ultrasound task, and optionally partially filled by a trainee and/or monitored person during fulfillment of the ultrasound task.

TABLE 1

| | |
|---|---|
| Task | Task name: |
| ID: | |
| Practitioner: | |
| Trainer: | |

Preset

| Ultrasound machine details | | | | | | | | | | | | | | |
|---|---|---|---|---|---|---|---|---|---|---|---|---|---|---|
| | | Focus | | | | | | | | Har. | | Manneq. details | | |
| number | Program | location | depth | zoom | angle | TGC | gain | R | power | Freq | OTI | Presentation | Orientation | Transducer |
| 1 | | | | | | | | | | | | | | |

Sub-tasks

| Ultrasound machine details | | | | | | | | | | | | | | |
|---|---|---|---|---|---|---|---|---|---|---|---|---|---|---|
| Sub- | | Focus | | | | | | | | Har. | | Manneq. details | | |
| task no. | Program | location | depth | zoom | angle | TGC | gain | R | power | Freq | OTI | Presentation | Orientation | Transducer |
| 1 | | | | | | | | | | | | | | |
| 2 | | | | | | | | | | | | | | |
| 3 | | | | | | | | | | | | | | |
| 4 | | | | | | | | | | | | | | |
| 5 | | | | | | | | | | | | | | |
| 6 | | | | | | | | | | | | | | |

An aspect of the above simplified description will now be described in more detail: how a target image is selected for comparison to the captured image.

In some embodiments of the invention, in order to know which target image is to be compared to the captured image, a location and direction of the ultrasound probe 110 are measured relative to the ultrasound subject 112.

Optionally, the ultrasound system 100 includes location and direction transmitters and sensors such as described in above-mentioned U.S. Pat. No. 5,609,485. Location and direction of the ultrasound probe 110 are obtained by the ultrasound system 100. Based on the location and direction of the ultrasound probe 110, the ultrasound system 100 provides a target image from a target image database.

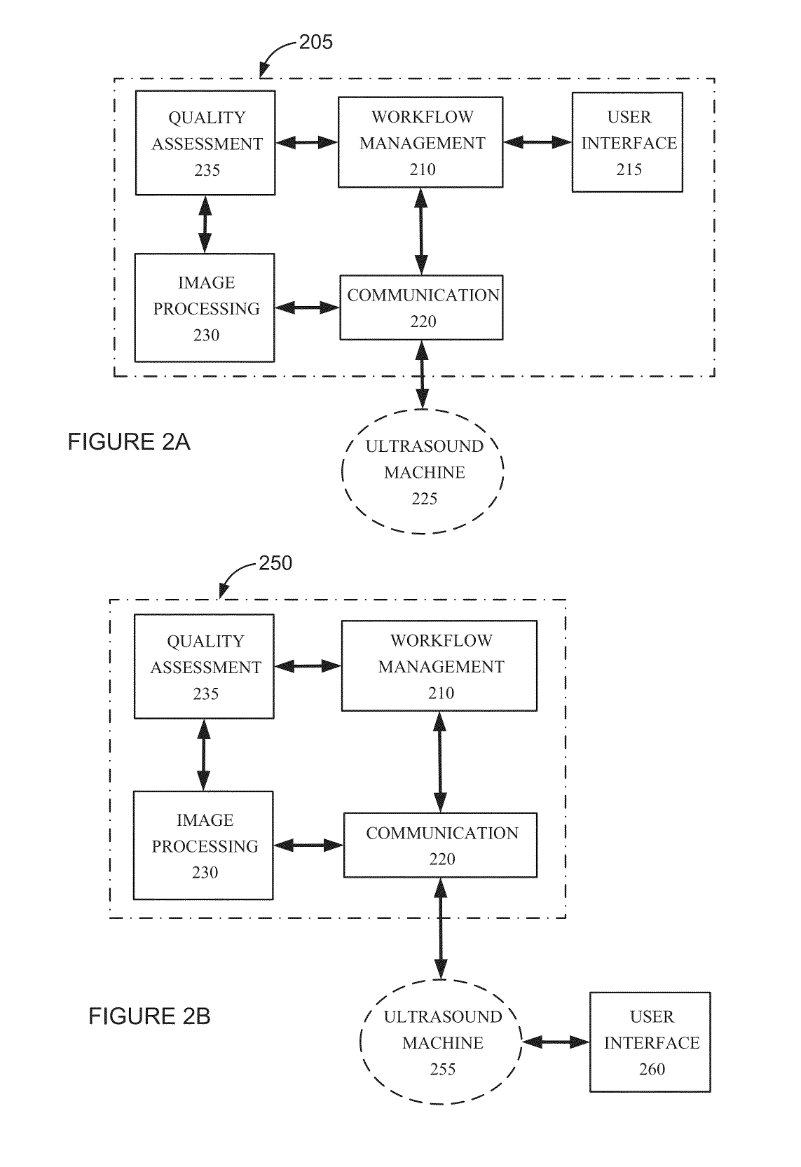

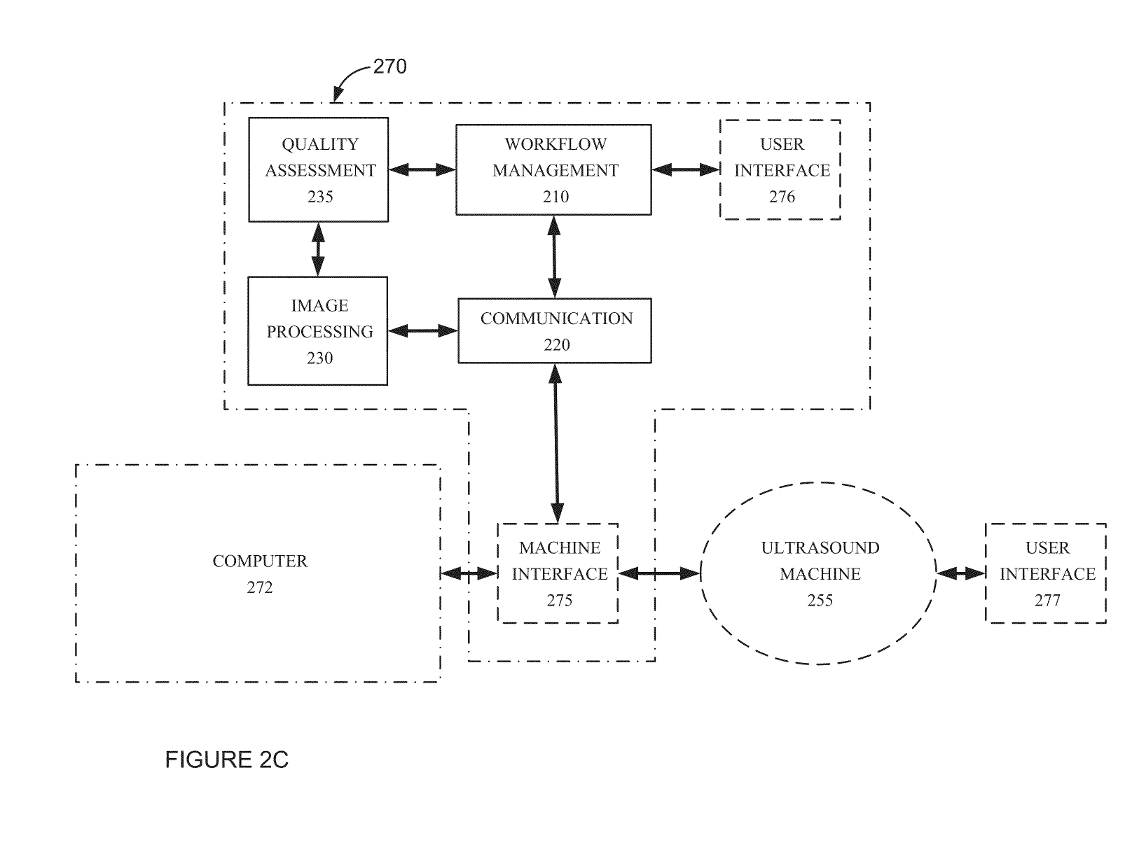

In some embodiments of the invention, in order to know which target image is to be compared to the captured image, an image processing unit (not shown in FIG. 1, but shown in FIGS. 2A and 2B) performs image manipulation of the captured image, extracting significant data describing the captured image. Based on the description data, a target image containing similar significant data is used for comparison. The comparison optionally measures differences between the captured image and the target image, optionally at a greater level of detail than used when retrieving the target image from the target image database.

In some embodiments of the invention, in order to know which target image is to be compared to the captured image, the target image is simply an image corresponding to the ultrasound task at hand. The practitioner-trainee is given a task to perform as part of an ultrasound session, and the image which the practitioner-trainee provides as the captured image is compared to an image corresponding to performance of the task. Naturally, if the trainee really missed performing the task by a wide margin, the target image will not be similar at all to the target image.

An aspect of the above simplified description will now be described in more detail: how the comparison of the captured image to the target image is made.

In some embodiments of the invention image processing is performed on the captured image, and results are compared to results of the same image processing performed on the target image. Optionally, the image processing results of the target images are kept stored and not recalculated.

It is noted that ultrasound tasks may optionally include imaging a specific part of subject anatomy, including a correct definition of orientation and identification of the specific part.

It is noted that ultrasound tasks may optionally include Doppler flow interpretation.

It is noted that ultrasound tasks may optionally include a specific 3D orientation of the ultrasound probe relative to the ultrasound subject in order to produce correct images.

It is noted that ultrasound tasks may optionally include guided invasive procedures.

Some aspects of a training system for ultrasound users include:
A training session which includes a clinical story line: a patient present with symptom A. What ultrasound scans do you intend to perform?
A series of ultrasound images are displayed, the trainee is required to stop the series at a significant image.
Questions may be presented to the trainee: how should an image be improved? What is a diagnosis based on the image? What should be a next ultrasound check be, based upon a diagnosis of a current image?
when a trainee achieves an acceptable image of a mannequin, the trainee may be presented with an image from an image database of pre-diagnosed ultrasound images.

Assessment of a User's Mechanical Performance of an Ultrasound Task

Proficient ultrasound users perform ultrasound tasks rapidly. They start off placing an ultrasound probe at a correct location for their task, they quickly refine the location and angle of the probe to reach good quality images of target organs for inspection, they correctly diagnose a patient's condition based on the images, optionally record the patient's condition, and optionally move on rapidly to acquiring new images, based on the patient's condition and/or based on following a specific ultrasound checkup protocol.

In some embodiments of the invention, an assessment is made of the mechanical proficiency of a user. A task is optionally split into subtasks: “find A”; “image A”, “find B”; “image B”, and possibly repeated. Which “B” is to be found after finding “A” may be dependent on a diagnosis of an image found for “A”, and/or on following a protocol which defines which “A”, “B”, and “C” to find, in which order.

One or more of the following details are optionally recorded about performance of each one of the subtasks:
start position of the ultrasound probe. The start position may be recorded by components of the example embodiment which measure location of an ultrasound probe, such as, by way of a non-limiting example, by cameras tracking a probe, or a mark on a probe, or a mark on a practitioner's hand.
duration for finding “A”, that is, time from starting a subtask, until an image for “A” is provided. Normally, although not necessarily, a shorter duration is better.
“track” used for finding “A”. The advancement from a start position to an image being provided for “A” may, in some embodiments of the invention, be measured as a series of positions and orientations (optionally three dimensional) of the ultrasound probe. Such a series describes a “track” used to reach “A”. A typical “track” is usually a combination of large movements, combined with fine corrections.
quality of image produced for subtask “A”.
diagnosis produced for subtask “A”.

It is noted that the start position, duration, and analysis of the track all optionally indicate a level of manual dexterity.

It is noted that the start position, and analysis of the track optionally indicate a level of spatial orientation.

In some embodiments of the invention, the track is analyzed by an ultrasound expert watching a recording of the images produced by the practitioner while traversing the track.

In some embodiments of the invention, the track is broken up by an automatic process which records a number and a duration of rapid and/or large movements, and a number and duration of slower and/or smaller movements.

A Reference Ultrasound Image Database

Reference, or target images, to which a practitioner's captured image is compared to, optionally include ultrasound images of an ultrasound subject on which the practitioner is trained and/or monitored. Such subjects are described above with reference to “Ultrasound subjects”. For example, the reference image database may include one or more of live patient images, mannequin images, phantom images, cadaver images, animal images, and so on.

In some embodiments of the invention the reference images are stored in an ultrasound image database. In some embodiments of the invention the ultrasound image database is included in the ultrasound task database.

It is noted that the reference image database may include Doppler measurements associated with the images, and/or Doppler data which is part of the images.

Image Processing

The image processing optionally includes:

(a) feature extraction, such as performed by feature extraction methods known in the art, by way of a non-limiting example a method known as “snakes” or “active contours”. By feature extraction of the captured image, and comparison to features which exist in a target image, the TAM system optionally, by way of a non-limiting example, detects whether the captured image is of the right body location, and of enough quality to view specific organs.

(b) histogram extraction, which optionally provides information, by way of a non-limiting example, on image contrast, on light area VS dark area, and so on, enabling, by way of a non-limiting example, assessing quality of an image.

(c) histogram correction, which enables, by way of a non-limiting example, to bring a captured image's histogram closer to a target image's histogram, for comparison purposes.

(d) gamma correction, which enables, by way of a non-limiting example, another method for bringing a captured image's histogram closer to a target image's histogram, for comparison purposes.

(e) magnifying the image, which enables, by way of a non-limiting example, to bring a captured image to be closer to a target image, for comparison purposes.

(f) rotating the image, which enables, by way of a non-limiting example, to bring a captured image to align with a target image, for comparison purposes.

(g) shifting the image, which enables, by way of a non-limiting example, to bring a captured image to align with a target image, for comparison purposes.

Comparing the captures image and the target image may involve magnifying, rotating, and shifting one or both of the images before performing the comparison.

In some embodiments of the invention the magnification is optionally performed based on a magnification setting of the ultrasound workstation 105 used when the captured image was taken, as retrieved by communication between a workflow management unit (not shown) and/or an image processing unit (not shown) and the ultrasound workstation 105.

In some embodiments of the invention the magnification, and/or rotation, and/or shifting are optionally performed based on: feature extraction from the captured image; pairing features with the target image; and performing the magnification, and/or rotation, and/or shifting in order to improve a fit of the two images before performing a detailed comparison.

The term “image” in all its grammatical forms is used throughout the present specification and claims interchangeably with the term “image portion” and its corresponding grammatical forms

It is noted that in ultrasound images, sometimes the content of an image portion are a target of a task or sub-task. It is only the image portion which needs to be of good quality, and only the image portion which should be assessed.

The portion may be identified by the user/practitioner, using a user interface to mark the portion, and/or the portion may be determined by image processing, such as, for example, using active contours to select the portion.

Quality Assessment

Quality assessment of the ultrasound task is optionally made by comparing elements of how the practitioner performed the task, and results of the performance of the task, with at least some stored data elements defined as proper and/or good performance of the task.

Elements compared include the following:

(a) Ultrasound machine settings. Potentially all setting which may be read by the TAM system, although a partial set of settings may be used to assess any one specific task. Additionally, some settings, such as contrast and/or brightness, may be read from the ultrasound machine, and/or deuced from image analysis of an ultrasound image.

(b) Quality of a captured image. The quality includes a stand-alone quality such as contrast, histogram measurements, and correct ultrasound subject target features as measured by feature extraction used by the TAM system. The quality includes comparison to target images.

(c) Accuracy of feature measurements performed by the practitioner, by way of some non-limiting examples: accuracy of bone length; and accuracy of fetal head circumference.

In some embodiments of the invention, when ultrasound task measurements are of a known ultrasound subject, such as a mannequin or a cadaver, the accuracy is optionally measured by comparing to such measurements in the target database, which are optionally made by experts, and represent an optimal measurement. The measurements in the databank optionally include a range of error within which training measurements are considered good/acceptable/sub-par.

In some embodiments of the invention, when ultrasound task measurements are of a new, unknown ultrasound subject, such as an actual patient, the accuracy is optionally measured by comparing to automatic measurements made on the captured image by the TAM system using feature extraction. The databank optionally includes a range of error within which training measurements are considered good/acceptable/sub-par.

(d) Detection of special features. Some ultrasound tasks optionally include detection of anomalous and/or deformed and/or special details in the ultrasound subject. Detection of such details may be dependent on performing the ultrasound task properly, or even at a good enough quality so as to be able to detect the details.

(e) Time taken to perform the ultrasound task.

(f) Adherence to a protocol which may be associated with an ultrasound task. For example: a protocol of an ultrasound scan of a fetus is supposed to include specific images and specific measurements. Have all of the images and measurements been taken? Been recorded? A protocol for “stomach pain” may include ultrasound imaging of specific organs, optionally also in a specific order. Has the protocol been performed in order? Images stored for each organ? Diagnosis for each organ?

Feedback

In some embodiments feedback is provided to a trainee, to a practitioner, to persons managing training, and/or to persons managing and/or monitoring the practitioner. The feedback may optionally be one or more of the following:

feedback on one or more items of a “measurement” group of data items, such as, by way of a non-limiting example, area, diameter, and distance;

feedback on one or more items of an “image setting” group of data items, such as, by way of a non-limiting example, contrast and brightness;

feedback on one or more items of an “orientation” group of data items, such as, by way of a non-limiting example, ultrasound probe orientation and mannequin orientation;

feedback on one or more items of a “position” or “location” group of data items, such as, by way of a non-limiting example, ultrasound probe position and mannequin position;

a grade and/or quality assessment for each stored ultrasound image;

what data was supposed to be stored with each ultrasound image;

what ultrasound machine settings, or setting ranges, were supposed to be stored with each ultrasound image;

a comparison of any one or more of target values, as optionally kept in a task database, with achieved values;

a comparison of task quality for a specific trainee/practitioner over time; and

a grade provided as feedback for performing an ultrasound task.

It is noted that the ultrasound subject 112 may optionally be any one of: an actual patient; a practice cadaver; an animal; an animal cadaver, and a mannequin. The target image database has target images of the ultrasound subject 112.

Having mentioned different types of ultrasound subjects 112, corresponding scenarios in which the ultrasound subjects 112 are used for training are envisaged. A mannequin is optionally used in a training setting, whether in an ultrasound training center, or in a training session in an ultrasound clinic or a medical center. A human patient is optionally used in any one of the scenarios in which the mannequin is used.

A cadaver is naturally envisaged to be used in a training center, not necessarily open to the non-practitioner public. An animal cadaver is also naturally envisaged to be used in a training center, not necessarily open to the non-practitioner public.

Reference is now made to FIG. 2A, which is a simplified block diagram illustration of an ultrasound TAM system 205 constructed and operational according to an example embodiment of the invention.

FIG. 2A depicts the ultrasound TAM system 205 constructed as an add-on unit to an ultrasound machine 225. The add-on may be packaged inside the ultrasound machine 225 cabinet, which is often quite spacious, as may be seen in FIG. 1. The add-on may be packaged in a separate enclosure, having communications via a communication module 220 and a communication connection to the ultrasound machine 225.

The ultrasound TAM system 205 includes a workflow management unit 210, connected and communicating with a user interface 215, a communication unit 220, and a quality assessment unit 235. The ultrasound TAM system 205 also includes an image processing unit 230, connected and communicating with the communication unit 220 and the quality assessment unit 235.

The communication unit 220 is connected to and communicating with the ultrasound machine 225.

A simplified example workflow of an ultrasound session will now be described, in order to illustrate functions performed by the above-mentioned units.

The ultrasound session is optionally started by the workflow management unit 210, and instructions are provided to a practitioner-trainee via the user interface 215.

The ultrasound session may be a training session, with a training task set for the practitioner-trainee; or the ultrasound session may be an assessment session, with the practitioner-trainee assessed on performance of an ultrasound task; or the ultrasound session may be an actual patient ultrasound checkup, monitored for quality by the ultrasound TAM system 205.

The practitioner-trainee performs the ultrasound task, and optionally indicates, via the user interface 215, that the ultrasound task is over, or that an image has been captured which is to be assessed.

The workflow management unit 210 causes the communication unit 220 to retrieve the captured image, and optionally machine settings, from the ultrasound machine 225. The captured image is sent to the image processing unit 230, which performs what image processing is necessary. The quality assessment unit 235 calculates quality measures for the image and/or the complete task, and optionally what feedback to provide to the ultrasound practitioner.

The quality measure produced by the quality assessment unit 235 may be in a acceptable/not-acceptable format; in a fuzzy-logic several-level format such as 3, 5, or 7 grades of quality; and in a numeric grade such as between a fail grade such as 0 or 55 and a perfect grade such as 100.

The quality measure produced by the quality assessment unit 235 may be separated into functional scores, such as associated with image quality and correct diagnosis, and geometric scores, such as associated with ultrasound probe angle, direction, location, dexterity of manipulation, and so on.

It is noted that the ultrasound TAM system 205 may optionally be connected to more than one ultrasound machine 225. The ultrasound TAM system 205 optionally conducts more than one ultrasound

Reference is now made to FIG. 2B, which is a simplified block diagram illustration of an ultrasound TAM system 250 constructed and operational according to another example embodiment of the invention.

FIG. 2B depicts the ultrasound TAM system 250 using a user interface 260 of an ultrasound machine 255. FIG. 2B emphasizes that some modules of the ultrasound TAM system 250 may be shared with the ultrasound machine 255.

The ultrasound TAM system 250 of FIG. 2B may still be constructed as an add-on unit to the ultrasound machine 255. The add-on may be packaged inside the ultrasound machine 255 cabinet, which is often quite spacious, as may be seen in FIG. 1. The add-on may be packaged in a separate enclosure, having communications via a communication module 220 and a communication connection to the ultrasound machine 255.

The ultrasound TAM system 250 includes a workflow management unit 210, a communication unit 220, and a quality assessment unit 235. The ultrasound TAM system 250 also includes an image processing unit 230, connected and communicating with the communication unit 220 and the quality assessment unit 235.

The communication unit 220 is connected to and communicating with the ultrasound machine 225. The user interface 260 of the ultrasound machine 255 communicates with the ultrasound TAM system 250 via the communication unit 220.

The simplified example workflow of an ultrasound session described above with reference to FIG. 2A also describes an example workflow of an ultrasound session for FIG. 2B, with changes as required to have the user interface 260 of the ultrasound machine provide user interface functionality for the ultrasound TAM system 250.

In many settings, and ultrasound machine is connected to a computer, which is used to store ultrasound findings and/or to communicate ultrasound findings and/or to manage ultrasound use.

Reference is now made to FIG. 2C, which is a simplified block diagram illustration of an ultrasound TAM system 270 constructed and operational according to yet another example embodiment of the invention;

FIG. 2C depicts the ultrasound TAM system 270 optionally connected between an ultrasound machine 255 and a computer 272.

In some embodiments the ultrasound TAM system 270 has a machine interface 275 which connects between the ultrasound machine 255 and the computer 272, and which sends some, if not all, of the ultrasound machine's 255 communications with the computer 272 to the ultrasound TAM system 270.

The ultrasound TAM system 270 of FIG. 2B may still be constructed as an add-on unit to the ultrasound machine 255, or to the computer 272. The add-on unit may be packaged inside the ultrasound machine 255 cabinet, or within the computer 272 cabinet. In some embodiments, the ultrasound TAM system 270 may include software modules running on the computer 272, and not require a computer of its own.

The ultrasound TAM system 270 includes a workflow management unit 210, a communication unit 220, and a quality assessment unit 235. The ultrasound TAM system 250 also optionally includes an image processing unit 230, connected and communicating with the communication unit 220 and the quality assessment unit 235.

The communication unit 220 is connected to and communicating with the ultrasound machine 225 through the machine interface 275.

The ultrasound TAM system 270 optionally includes a user interface. In some embodiments of the invention the user interface is included in the ultrasound machine 255, as depicted by optional user interface 277 of FIG. 2C. In some embodiments of the invention the user interface is included in the ultrasound TAM system 270, wherever the ultrasound TAM system 270 is packaged, as depicted by optional user interface 276 of FIG. 2C.

The simplified example workflow of an ultrasound session described above with reference to FIG. 2A also describes an example workflow of an ultrasound session for FIG. 2C, possibly with changes as required to have the user interface 277 of the ultrasound machine provide user interface functionality for the ultrasound TAM system 270, or possibly with changes as required to have the user interface 276 of the ultrasound TAM system 270 provide user interface functionality.

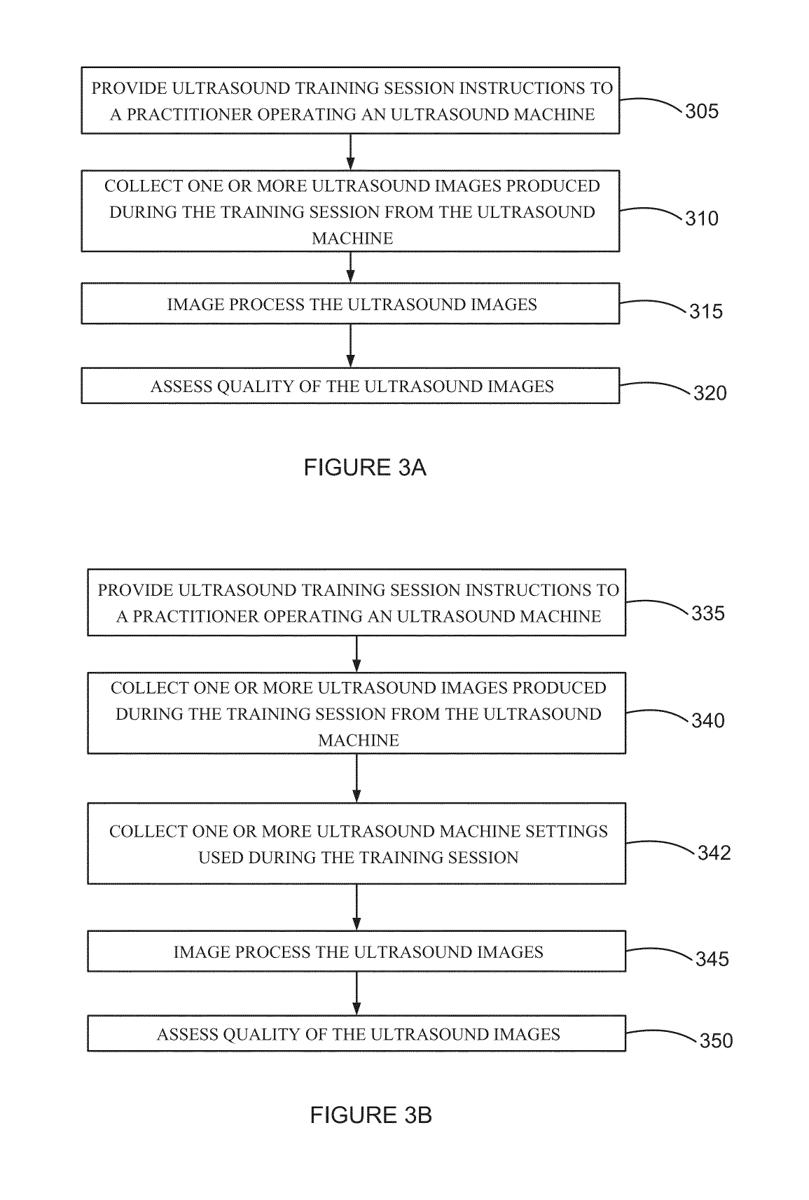

Reference is now made to FIG. 3A, which is a simplified flow chart illustration of an example embodiment of the invention, used for training ultrasound practitioners.

FIG. 3A specifically illustrates an example embodiment of a training session:

ultrasound training session instructions are provided to a practitioner operating an ultrasound machine (305);

one or more ultrasound images produced during the training session are collected from the ultrasound machine (310);

the ultrasound images undergo image processing as needed (315); and

quality of the training session is assessed based, at least in part, on quality of the ultrasound images (320).

It is noted that in some embodiments, one or more ultrasound machine settings which were in use during the training session are collected, and the assessing is performed based, at least in part, on the ultrasound machine settings.

Reference is now made to FIG. 3B, which is a simplified flow chart illustration of another example embodiment of the invention, used for training ultrasound practitioners.

FIG. 3B specifically illustrates an example embodiment of a training session, in which both ability to produce a good image (mechanical ability), and using correct ultrasound machine settings are evaluated:

ultrasound training session instructions are provided to a practitioner operating an ultrasound machine (335);

one or more ultrasound images produced during the training session are collected from the ultrasound machine (340);

one or more ultrasound machine settings used during the training session are collected from the ultrasound machine (342);

the ultrasound images undergo image processing as needed (345); and

quality of the training session is assessed based, at least in part, on quality of the ultrasound images, and at least in part on the machine settings used during the training session (350).

It is noted that in some embodiments of the invention the one or more ultrasound machine settings are optionally input by the ultrasound practitioner, rather than collected from the ultrasound machine.

It is noted that in some embodiments, one or more ultrasound probe position and ultrasound probe direction measurements are collected, as used when performing the ultrasound checkup and/or when capturing the ultrasound image, and the assessing is performed based, at least in part, on the ultrasound probe position and ultrasound probe direction measurements.

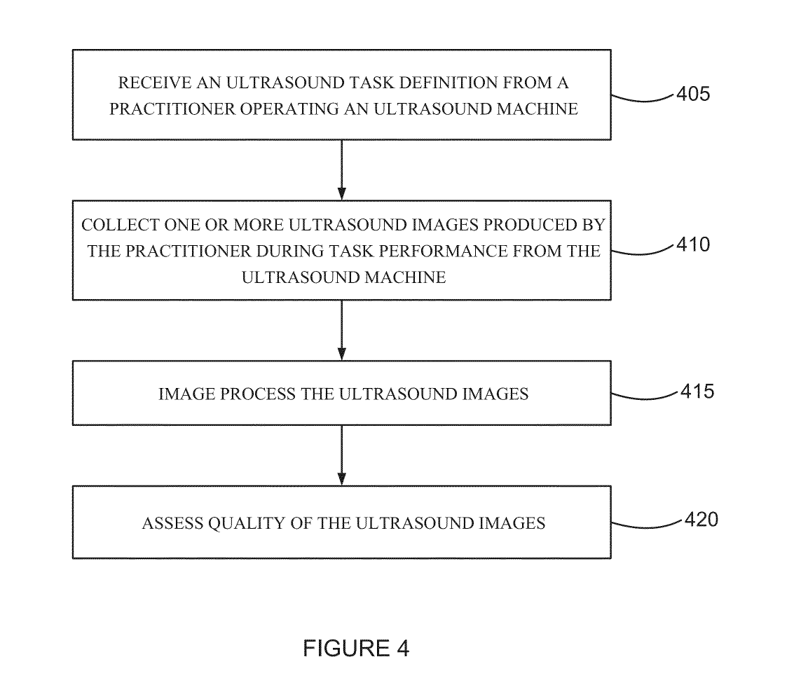

Reference is now made to FIG. 4, which is a simplified flow chart illustration of an example embodiment of the invention, used for monitoring ultrasound practitioners.

FIG. 4 specifically illustrates an example embodiment of a monitoring session, optionally even on the floor of a hospital ward:

an ultrasound task definition is input from a practitioner operating an ultrasound machine (405);

one or more ultrasound images produced during the ultrasound task are collected from the ultrasound machine (410);

the ultrasound images undergo image processing as needed (415); and

quality of the training session is assessed based, at least in part, on quality of the ultrasound images (420).

In some embodiments of the invention, software for performing training, assessment and monitoring is embedded in an ultrasound TAM system with no add-on enclosure at all. Typical ultrasound systems include a computer for management, therefore software units such as a workflow management unit 210, a user interface 215, a communication unit 220, a quality assessment unit 235, and an image processing unit 230, are all embedded as software in a computer which is part of an ultrasound machine such as the ultrasound machine 255 of FIG. 2B.

Management of an Ultrasound User Monitoring System

Some embodiments of the invention include a system for monitoring users of ultrasound systems. Any of the quality measures may be monitored over time, and feedback may be provided to quality managers and/or to the trainee or practitioner.

The users may be trained ultrasound practitioners, such as doctors and technicians, some more familiar with ultrasound technique than others.

In some embodiments of the invention quality of performing a task is compared to a trainee/practitioner's previous work. In some embodiments of the invention quality of performing a task is compared to a trainee/practitioner's cohort, that is, persons possessing similar ultrasound qualifications. In some embodiments of the invention quality of performing a task is compared to quality of previously performing, or others performing, the same task. In some embodiments of the invention quality of performing a task is compared to quality of previously performing, or others performing, a similar, but not equal, task, or even to a quality measure of any task, dissimilar as it may be.

Optionally, ultrasound task subjects suffering from low grades, such as echo ultrasounds suffering from low grades, may cause a re-training of a clinic or ward in cardiac ultrasounds.

Optionally, ultrasound tasks graded as problematic, that is, having low grades, may be flagged, and the practitioners producing the low-graded tasks may be sent for additional training.

In some embodiments of the invention, monitoring is optionally performed by collecting data produced by users of ultrasound machines.

Monitoring may be performed in a clinic/hospital ward scenario. An ultrasound machine fitted with the TAM system may be available to medical staff (physicians, sonographers, students nurses), and all use of the ultrasound machine and TAM system may be recorded and quality and accuracy of their work assessed. Studies of ultrasound quality may be collected and analyzed based on a temporal basis, such as a weekly quality indicator, based on task subject, such as quality of fetus head measurements.

In some embodiments of the invention the ultrasound machines are connected to different embodiments of the Training, Assessment, and Monitoring (TAM) system, which collect data for monitoring. The TAM system has data gathering capabilities which are described above, and which can optionally enhance a monitoring system.

In some more-encompassing embodiments, the ultrasound machines are connected to a TAM system embodiment which measures ultrasound probe location and direction.

In some less-encompassing embodiments, the ultrasound machines are connected to a TAM system embodiment which collects ultrasound machine settings, ultrasound images, and text input by a user.

In some even-less-encompassing embodiments, the ultrasound machines are connected to a TAM system embodiment which collects only ultrasound images and text input by a user.

Quality assessment of the monitored users includes assessing quality of at least some of:

filling out all fields of a report according to a set protocol;

reaching a correct diagnosis (in some cases optionally by comparison to non-ultrasound results, such as birth weight and/or cranial circumference of a baby born a short time after ultrasound, and, from another perspective, post-mortem performed a short time after ultrasound providing results for comparison, or surgery providing results a short time after ultrasound); and

additional quality measures such as described above with reference to “Quality assessment”.

In some embodiments of the invention, some of the quality assessment may be made by an ultrasound expert monitoring results of an ultrasound session.

In some embodiments of the invention, some of the quality assessment may be made by an automatic procedure, such as assessing image quality by image processing, as described above.

In some embodiments of the invention, some of the quality assessment may be made by an ultrasound expert, and some of the quality assessment may be made by an automatic procedure, and the assessments may be combined.

Tracking and reporting of users being monitored may be done at individual user level, user group level, departmental level, and so on.

Selection of users to be monitored may be done according to a quota system, where monitored users must be assessed on a certain number of ultrasound tasks performed; and may be done with the number of tasks split so that each monitored user is monitored on a certain number of ultrasound tasks for one specific task, and a different number of ultrasound tasks for a different specific task. Rare ultrasound tasks may all be monitored, so that a rare procedure is always monitored and feedback provided, in order to increase awareness and quality for that ultrasound task.

Rare ultrasound tasks may be presented to practitioners as training tasks, since on a day-by-day basis practitioners may not get enough practice at the rare tasks. The rare tasks are optionally set up on practice mannequins, and optionally include images from an image database of ultrasound images of rare conditions.

It is noted that a feature of monitoring (and training) of ultrasound users is that while a protocol may exist, for specific ultrasound tasks, of what organs should be scanned, and what images should be produced, the order in which the organs are scanned, and/or the order of sub-tasks, is not necessarily fixed. A protocol optionally includes a list of what sub-tasks should be performed, optionally without an order in which they should be performed.

In some cases, the order is important, for example, when a sub-task produces a diagnosis of X, the next sub-task should be a scan of Y.

Optionally, a quality assessment of a sub task includes one or more of: producing a correct image, at a correct location, with good quality, as determined by an ultrasound expert providing the assessment, and/or as determined by image comparison with one or more images from an image database; producing correct measurements; and producing a correct diagnosis.

Tracking and reporting of users being monitored may be done at real-time, optionally displaying on a monitoring display who is currently operating under monitor, optionally displaying an ultrasound image which a monitored practitioner is presently producing, optionally displaying ultrasound machine setting, optionally displaying input which the practitioner enters into the ultrasound machine user interface.

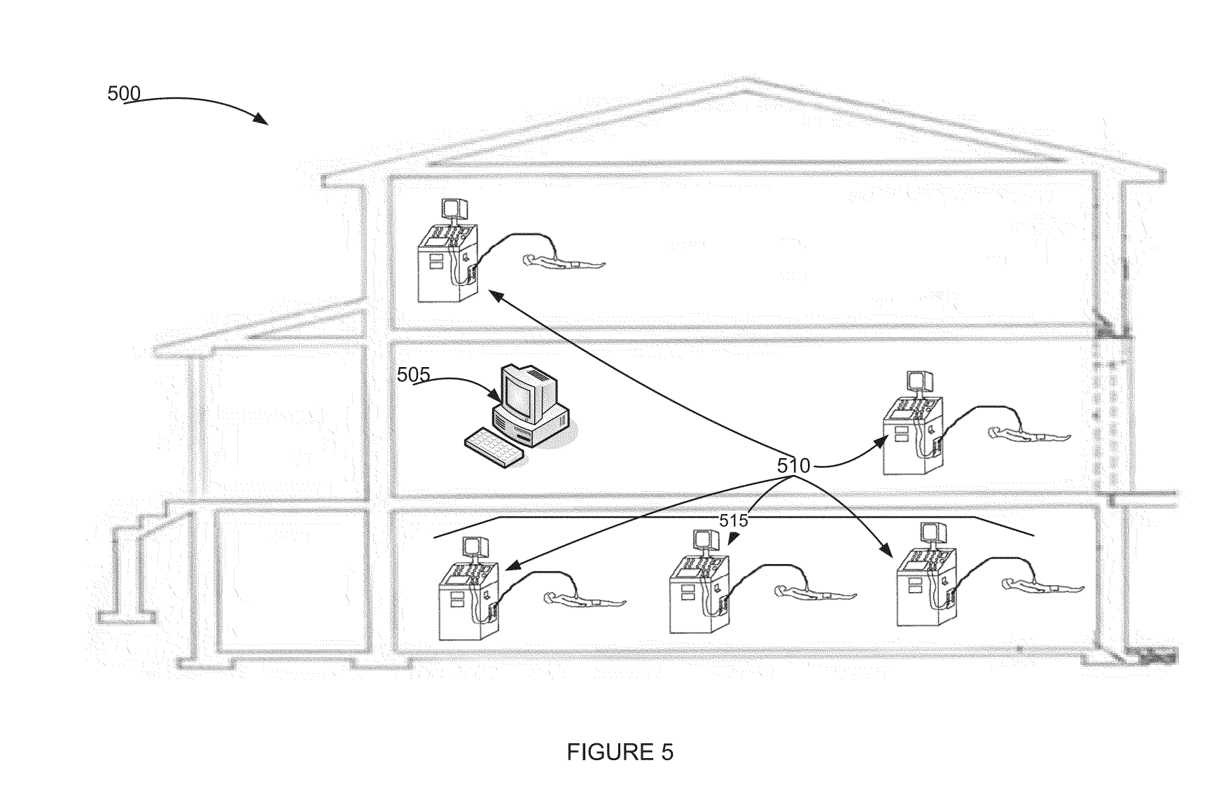

Reference is now made to FIG. 5, which is a simplified illustration of an ultrasound user monitoring system 500, constructed and operational according to an example embodiment of the invention.

FIG. 5 depicts a computer 505 which communicates (network not shown) with TAM systems 510, distributed in several floors of a small hospital. Optionally, a first location in which the TAM systems 510 are placed is an Ultrasound training center 515. Optionally, other locations in which the TAM systems 510 are placed may be hospital wards.

It is expected that during the life of a patent maturing from this application many relevant ultrasound machines will be developed, and the scope of the term ultrasound machine is intended to include all such new technologies a priori.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for training practitioners in use of an ultrasound system comprising:
a unit for managing workflow of an ultrasound training session;
a user interface for providing ultrasound training session instructions to a practitioner operating an ultrasound machine and for receiving input from a trainee;
a unit for communication with the ultrasound machine, for collecting one or more ultrasound images produced during the training session from the ultrasound machine;
a unit for image processing the ultrasound images; and
a unit for assessing quality of the ultrasound images.

2. A system according to claim 1 and further comprising a unit for measuring ultrasound probe orientation.

3. A system according to claim 1 and further comprising a unit for measuring mannequin orientation.

4. A system according to claim 1 in which the unit for image processing the ultrasound images is configured to perform automatic feature extraction on the ultrasound images.

5. A system according to claim 1 and further including a database of ultrasound training sessions.

6. A system according to claim 5 in which the database comprises target ultrasound images associated with the training sessions.

7. A system according to claim 5 in which the database comprises metadata associated with the training sessions.

8. A system according to claim 5 in which the database comprises metadata associated with the target ultrasound images.

9. A system according to claim 1 in which the unit for communication with the ultrasound machine is also configured to collect ultrasound machine settings.

10. A system according to claim 1 and further comprising a unit for measuring ultrasound probe position and ultrasound probe orientation.

11. A system according to claim 10 and further adapted to record a series of positions and orientations used while performing an ultrasound task.

12. A method for training practitioners in use of an ultrasound system comprising:
providing ultrasound training session instructions to a practitioner operating an ultrasound machine;
collecting one or more ultrasound images produced during the training session from the ultrasound machine;
image processing the ultrasound images; and
assessing quality of the training session based, at least in part, on assessing quality of the ultrasound images.

13. A method according to claim 12 in which the assessing quality of the ultrasound images comprises measuring contrast of the ultrasound images.

14. A method according to claim 12 in which the image processing comprises feature extraction.

15. A method according to claim 12 in which:
the providing ultrasound training session instructions comprises providing instructions from a database of ultrasound training sessions; and
the image processing the ultrasound images comprises comparing the ultrasound images produced during the training session to ultrasound images stored in the database of ultrasound training sessions.

16. A method according to claim 14 in which the assessing quality of the training session comprises comparing metadata associated with the ultrasound images produced during the training session to metadata stored in the database of ultrasound training sessions.

17. A method according to claim 14 and further comprising:
collecting one or more ultrasound machine settings in use during the training session; and
in which the assessing quality of the training session comprises comparing the one or more ultrasound machine settings in use during the training session to ultrasound machine settings stored in the database of ultrasound training sessions.

18. A method according to claim 16 in which the assessing quality of the training session comprises comparing measurements made by the practitioners during the training session to metadata stored in the database of ultrasound training sessions.

19. A method according to claim 16 in which the assessing quality of the training session comprises comparing measurements made by the practitioners during the training session to measurements of features in the ultrasound images performed by automatic feature extraction on the ultrasound images.

20. A method according to claim 12 and further comprising:
collecting one or more ultrasound machine settings in use during the training session; and
performing the assessing based, at least in part, on the ultrasound machine settings.

21. A method according to claim 20 in which the assessing quality of the training session comprises comparing ultrasound machine settings to ultrasound machine settings stored in the database of ultrasound training sessions.

22. A method according to claim 12 and further comprising:
collecting one or more ultrasound probe position and ultrasound probe orientation measurements; and
performing the assessing based, at least in part, on the ultrasound probe position and ultrasound probe orientation measurements.

23. A method according to claim 22 and further comprising:
recording a series of positions and orientations used while performing an ultrasound task; and
performing the assessing based, at least in part, on the series.

24. Software for training practitioners in use of an ultrasound system comprising:
a unit for managing workflow of an ultrasound training session;
a user interface for providing ultrasound training session instructions to a practitioner operating an ultrasound machine and for receiving input from a trainee;
a unit for communication with the ultrasound machine, for collecting one or more ultrasound images produced during the training session from the ultrasound machine;
a unit for image processing the ultrasound images; and
a unit for assessing quality of the ultrasound images.

25. Software for monitoring practitioner use of an ultrasound system comprising:
a unit for managing workflow of an ultrasound training session;
a user interface for providing ultrasound training session instructions to a practitioner operating an ultrasound machine and for receiving input from a trainee;
a unit for communication with the ultrasound machine, for collecting one or more ultrasound images produced during the training session from the ultrasound machine;
a unit for image processing the ultrasound images; and
a unit for assessing quality of the ultrasound images.

26. A method for monitoring practitioner proficiency in use of an ultrasound system comprising:
providing the practitioner with an ultrasound task definition;
collecting one or more ultrasound images produced by the practitioner during performance of the ultrasound task from an ultrasound machine;
image processing the ultrasound images; and
assessing quality of the ultrasound images.

27. A method for monitoring practitioner proficiency in use of an ultrasound system comprising:
having the practitioner perform an ultrasound task on a system of claim 1; and
assessing quality of the ultrasound task.

28. The method according to claim 27 and further comprising comparing measurements of a fetus made by the practitioner based on the ultrasound task, to measurements made after birth.

29. The method according to claim 27 and further comprising comparing measurements made by the practitioner based on the ultrasound task, to measurements made post-mortem.

30. The method according to claim 27 and further comprising comparing measurements made by the practitioner based on the ultrasound task, to measurements made after surgery.
